(19) United States
(12) Patent Application Publication
(10) Pub. No.: US 2016/0259904 A1
(43) Pub. Date: Sep. 8, 2016

(54) SYSTEM AND METHOD FOR PROVIDING DISPENSING SECURITY FOR CONTROLLED SUBSTANCES WITHIN A CARE FACILITY

(71) Applicant: ABIDE TECHNOLOGIES, LLC, Forney, TX (US)

(72) Inventor: RICK WILSON, Forney, TX (US)

(21) Appl. No.: 15/059,042

(22) Filed: Mar. 2, 2016

Related U.S. Application Data
(60) Provisional application No. 62/127,310, filed on Mar. 3, 2015.

(51) Int. Cl. G06F 19/00; B65D 83/04

(52) U.S. Cl. CPC G06F 19/3406; G06F 19/3462; B65D 83/04

(57) ABSTRACT

A system for dispensing medication includes a secure first compartment for storing medications. A lock mechanism secures an access to the secure first compartment. At least one sensor detects an access to the secure first compartment and generates an access signal responsive thereto. An email notification generator generates and transmits an email to a predetermined individual responsive to receipt of the access signal from the at least one sensor.

### CROSS-REFERENCE TO RELATED APPLICATIONS

This application claims benefit of U.S. Provisional Application No. 62/127,310, filed Mar. 3, 2015, entitled SYSTEM AND METHOD FOR PROVIDING DISPENSING SECURITY FOR CONTROLLED SUBSTANCES WITHIN A CARE FACILITY (Atty. Dkt. No. RDPH-32512), the specification of which is incorporated by reference herein in its entirety.

### TECHNICAL FIELD

The present invention relates to remote medication dispensing systems, and more particularly, to a security system for monitoring and controlling accesses to remote medication dispensing systems.

### BACKGROUND

Within healthcare facilities there is a need for dispensing drugs to patients. These drugs may be for physical or psychological issues and many of these drugs comprise controlled substance that are under government Schedule II guidelines. These drugs are often stored at non-pharmacy locations where there is a potential for abuse of the drugs by unauthorized accesses. Thus, there is a need for controlling the manner in which controlled substances are dispensed at a location that may be remotely located from a pharmacy in a manner that limits the use to authorized individuals and provides evidence of unauthorized accesses by third parties.

### SUMMARY

The present invention, as disclosed and described herein, in one aspect thereof, comprises a system for dispensing medication that includes a secure first compartment for storing medications. A lock mechanism secures an access to the secure first compartment. At least one sensor detects an access to the secure first compartment and generates an access signal responsive thereto. An email notification generator generates and transmits an email to a predetermined individual responsive to receipt of the access signal from the at least one sensor.

### BRIEF DESCRIPTION OF THE DRAWINGS

For a more complete understanding, reference is now made to the following description taken in conjunction with the accompanying Drawings in which:

FIG. 1 illustrates the operating environment of a remote medication dispensing system;

FIG. 2 is a block diagram illustrating a security system for use with a remote medication dispensing system;

FIG. 3 illustrates separated secure canister compartments and general canister compartments within a remote medication dispensing system;

FIG. 4 illustrates the doors and locks associated with the separate secure canister compartments and general canister compartments of a remote medication dispensing system;

FIG. 5 illustrates the use of smart chip sensors for tracking movement of medications from the canister compartments of the remote medication dispensing system;

FIG. 6 is a flow diagram describing the manner in which medications are dispensed through the remote medication dispensing system;

FIG. 7 illustrates the various reports available with respect to the dispensing of medications;

FIG. 8 is a flow diagram illustrating the generation of an email notification responsive to an access of a controlled substance compartment; and

FIG. 9 illustrates the manner in which an individual may access video feeds responsive to an email notification indicating access of a controlled substance compartment.

### DETAILED DESCRIPTION

Referring now to the drawings, wherein like reference numbers are used herein to designate like elements throughout, the various views and embodiments of a system and method for providing dispensing security for controlled substances within a care facility are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

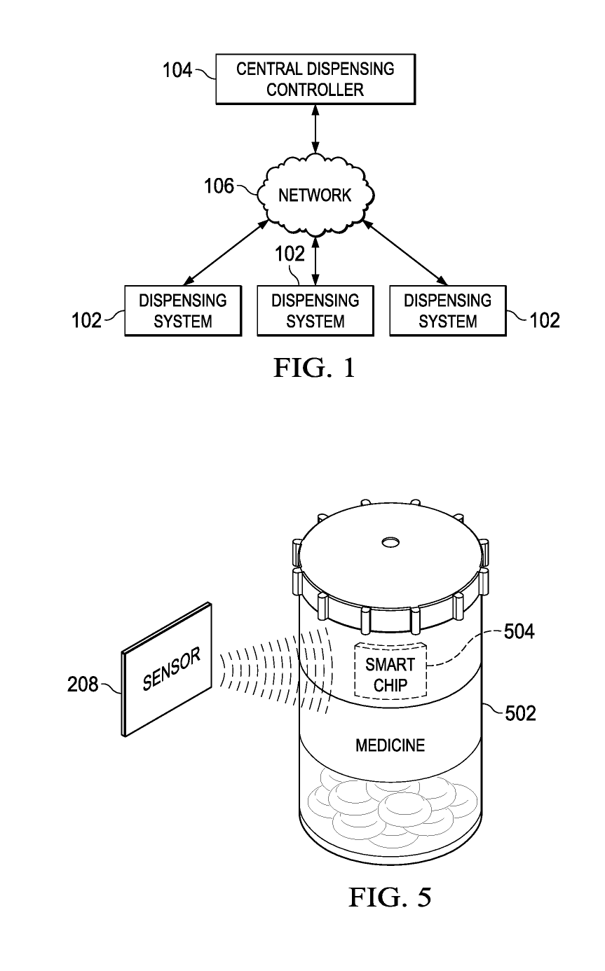

Referring now to the drawings, and more particularly to FIG. 1, there is illustrated an operating environment for a remote medication dispensing system. Within healthcare facilities there is often a need for dispensing drugs to patients. These drugs may be for physical or psychological issues and many of these drugs comprise controlled substances that are under government regulations and guidelines. While many healthcare facilities include a pharmacy, many locations providing patient healthcare do not include an on-site pharmacy facility. When controlled substances are stored at a non-pharmacy location, there is a potential for abuse of the drugs by nefarious third parties. One example of a remote medication dispensing system comprises the AscribeRX™ system. The AscribeRX™ system provides a system for monitoring and dispensing drugs at a remote location while providing centralized control functionalities. The system controls the manner in which controlled substances are dispensed at a non-pharmacy location in a manner that limits use to authorize parties and provides evidence of unauthorized accesses by unauthorized third parties.

A plurality of medication dispensing systems 102 are located at various remote locations such as nursing homes, patient out care facilities, etc. The medication dispensing system 102 provides a controlled and managed dispensing of medications that may be managed from a central dispensing controller 104 over a connecting network 106. The connecting network 106 may be a public network such as the Internet or a private network providing dedicated connections between the central dispensing controller 104 and a plurality of medication dispensing systems 102.

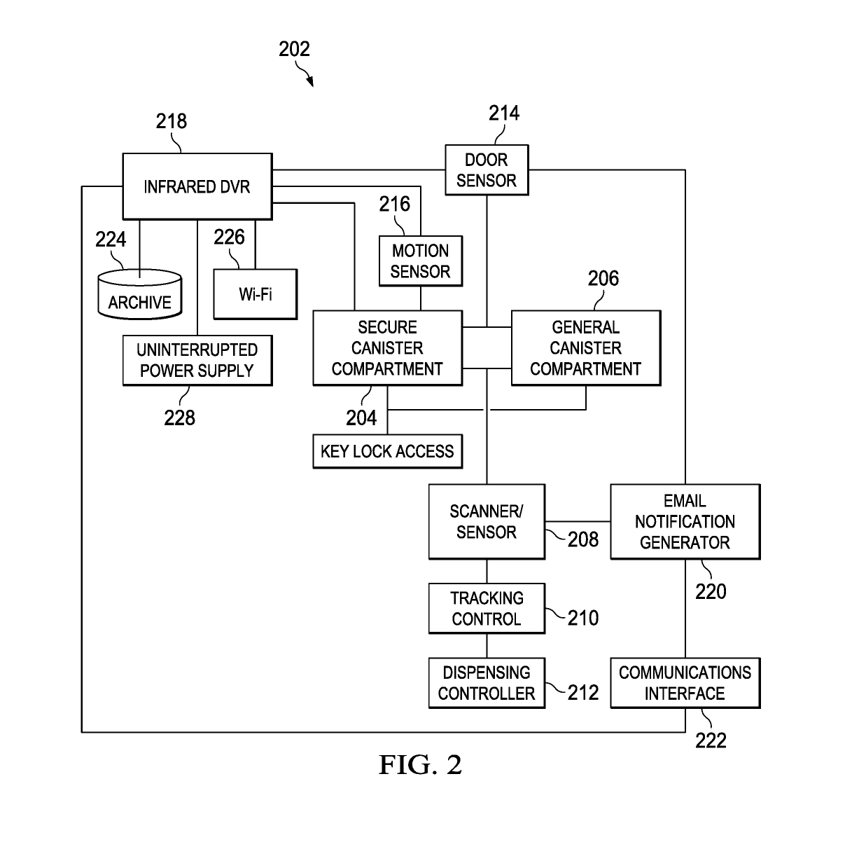

Referring now to FIG. 2, there is illustrated a block diagram of a system 202 providing dispensing security for controlled substances at a remote medication dispensing system 102. The dispensing security system 202 provides for the secured dispensation of Schedule II medications from an on-site medication dispensing system and implement security procedures for the dispensing of these controlled substances. Schedule II medications include drugs such as hydrocodone. Schedule II medications comprise a significant percentage of commonly dispense drugs and require highly restrictive rules with respect to the dispensation thereof. The dispensing security system 202 includes a secure canister compartment 204 and a general canister compartment 206. The secure canister department 204 protects drugs that are classified as Scheduled II medications. The general canister compartment 206 are used for other generally dispense medications that are not classified as Schedule II.

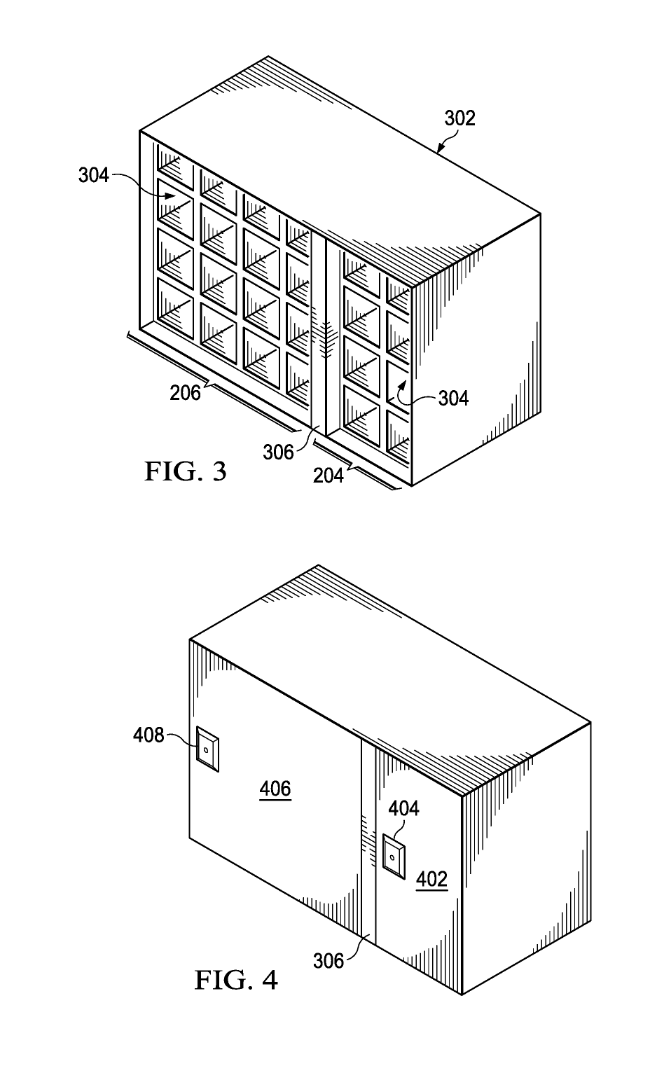

Referring now also to FIG. 3, there is illustrated the medication container 302 including the secure canister compartment 204 and the general canister compartment 206. Each of the secure canister compartment 204 and the general canister compartment 206 include slots 304 for receiving the medications to be dispensed. Canisters containing the medications are placed within the slots 304 and stored there until needed for dispensing to a patient. A divider 306 separates the secure canister department 204 from the general canister department 206. Also, as shown in FIG. 4, the secure canister compartment 204 has a separate door 402 and locking mechanism 404 associated therewith. Similarly, the general canister compartment 206 has its own door 406 and locking mechanism 408 associated therewith. The separate compartment doors 402, 406 provide segregation of the controlled medications from the non-controlled medications. Additionally, differing parties will have access to the compartments by controlling access to keys associated with a locking mechanisms 404 and 408. Only a limited no number of individuals will have a key for locking mechanism 404 associated with the secure canister compartment 204 containing the controlled medications. This provides one manner of limiting access to the medications within the remote dispensing system 102. The key to the controlled substance compartment 204 restricts access to designated individuals without compromising access to non-controlled substances within the general canister compartment 206.

Referring now back to FIG. 2 and to FIG. 5, when medications 502 are removed from either the general canister compartment 206 or secure canister compartment 204, a scanner/sensor 208 detects the removal of the medication 502. The medication 502 is detected by the scanner/sensor 208 using a smart chip 504 that is associated with the medication container. The sensor 208 detects the presence of the smart chip 504 as the medication 502 is removed from either of the general canister compartment 206 or the secure canister compartment 204. The sensor/scanner 208 will have the ability to determine which compartment the medication 502 has been removed from. The signal from the sensor 208 is provided to a tracking control 210 associated with the security system 202. The tracking control 210 will track the current contents of each of the general canister compartment 206 and the secure canister compartment 204. The tracking controller 210 enables the system to know the medications that are entering the compartments and leaving the compartments at any particular point in time.

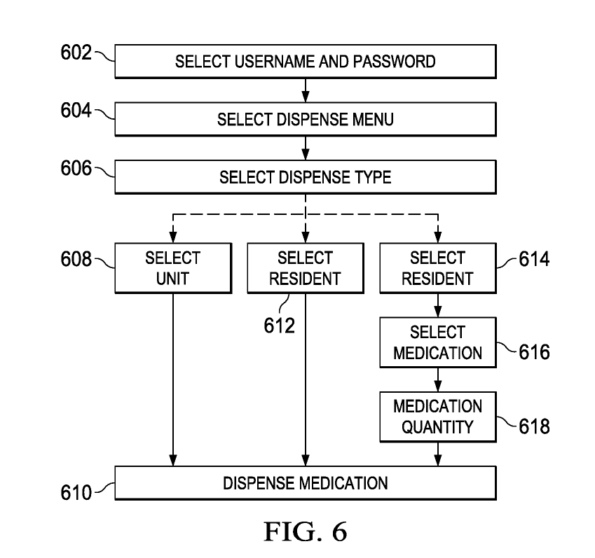

The dispensing controller 212 works in conjunction with the tracking control 210 in order to track and manage to whom various medications from the general canister compartment 206 and the secure canister compartment 204 are being dispensed. The dispensing controller 212 limits re-dispensing of medications to patients multiple times and provides advanced reporting of all drug related dispensing activities. The dispensing of medicines occurs through the dispensing controller 212 and involves, as illustrated in FIG. 6, a user selecting a username and entering a password at step 602. After the user is logged on to the system, a dispense order menu is selected from the main menu screen at step 604, and the type of dispensing of medication is selected at step 606. This can be either a routine daily medication order, a new medication order or an as needed medication order (PRN medication). For a routine daily medication, the user selects the unit from the unit list at step 608 and dispenses the medication by selecting dispense at set step 610. If a new medication is being dispensed, the resident is selected from the resident list at step 612 and passes to step 610 to dispense the medication. If an as needed medication is selected, the resident is first selected at step 614. The medication to be dispensed is selected from the medication list at step 616 and the medication quantity is then selected at step 618. The medication may then be dispensed at step 610.

Re-dispensing of medications may also be carried out either by resident wherein a particular resident is selected and a dose to dispense is indicated. In order to re-dispense, a reason for the re-dispensing of the medication must be indicated. Alternatively, medications may be re-dispense based upon the packet number that is being re-dispensed or a range of packet numbers.

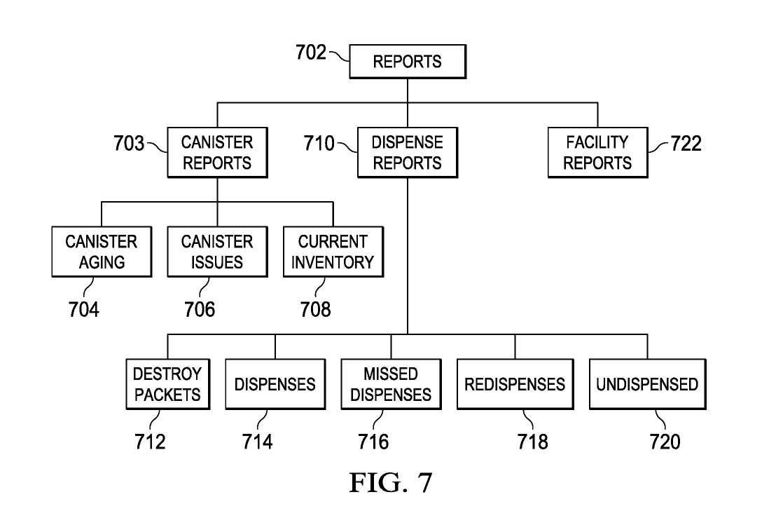

The dispensing controller 212 also provides a number of reporting functionalities enabling reports to be provided based upon a number of parameters. Reports are selected from menus based upon the type of information that is desired by the user. Each report contains an upper and lower sections, the upper section contains the selected report parameters and the lower section displays the report results. Referring now to FIG. 7, there is illustrated the various types of reports 702 that may be provided. Canister reports 703 include Canister aging reports 704 that display all canisters that are in the system and includes information including but not limited to the number of days since the canister has been filled, the number of days until the canister expires, the remaining quantity within the canister and the canister state. The canister issues report 706 displays all canisters that are in the system and includes but is not limited to information relating to jammed canisters, empty canisters, expired canisters, remaining canisters and the canister state. The current inventory report 708 displays all canisters that are within the system and includes information relating to medication name, NDC, empty status, canister fill expiration date and canister state.

Dispense reports 710 include the destroy packets report 712 that displays all doses that were dispensed from the install date selected in the parameters in destroy or “X” packets. The report includes information such as packet number, username, resident and dispensed date. The dispenses report 714 displays all packets that were dispensed from the install date selected in parameters. The report includes original dispenses, re-dispenses and destroy packet dispenses. It also may include information related to the username prescriptions (serial) number, medication name and dispensed date. The missed dispenses report 716 displays all doses that were available in ODS (OnsiteRX Dispensing System) but were not dispensed within the designated administration window. The report includes information related to prescription (serial) number, resident, medication name and the date/time the dose became available to dispense in ODS. The re-dispenses report 718 displays all doses that were re-dispensed from the install date selected in the parameters and includes information such as username, prescription (serial) number, medication name and dispensed date. The un-dispensed doses report 720 displays all doses available to dispense in ODS that have not yet been dispense. The report includes information such as resident, medication name and administration date and time.

Facility reports 722 may also be provided to provide facility information, prescription information, residents information and ODS access log information.

Various sensors such as door sensor 214 and motion sensor 216 detect accesses of the secure canister compartment 204 by individuals. The door sensor 214 detects when the secure canister compartment door is opened and generates control signals to an infrared DVR 218 and email notification generator 220 in response thereto. Similarly, the motion sensor 216 detects movement within the secure canister compartment 204 to detect the removal of medications from the compartment and generates control signals to the infrared DVR 218 and email notification generator 220.

The infrared DVR 218 provides a camera and recording media for taking and storing images (photographs and/or videos) of an individual that is accessing the secure canister compartment. The infrared DVR 218 may provide a live video feed to a communications interface 222 for contemporaneous viewing by an individual and/or may store the information within a local archive database 224. The infrared DVR 218 may also provide a Wi-Fi connection 226 for wirelessly communicating the information to third parties. The infrared DVR 218 and associated camera are powered by an uninterruptible power supply (UPS) 228 in order to provide continuous monitoring of it the secure canister compartment 204.

The access indication of the secure canister compartment 204 by either the door sensor 214 or the motion sensor to 16 causes an email notification generator 220 associated with the security system 202 to generate an email notification to a responsible party indicating that the secure canister compartment 204 has been opened. The email could be sent, for example, to a director of nursing or other specified recipient when the controlled substance doors are open. The email could include an HTTP link to the feed provided from the infrared DVR 218 which has also been triggered by the sensors to provide a dedicated view of the controlled substances compartment and provide video monitoring and online access to the archive footage of the access to the secure canister compartment 104. The emails generated by the email notification generator 220 are transmitted out from the system 202 via the communications interface 222 providing access to the Internet, local Wi-Fi network or other data or voice communications network.

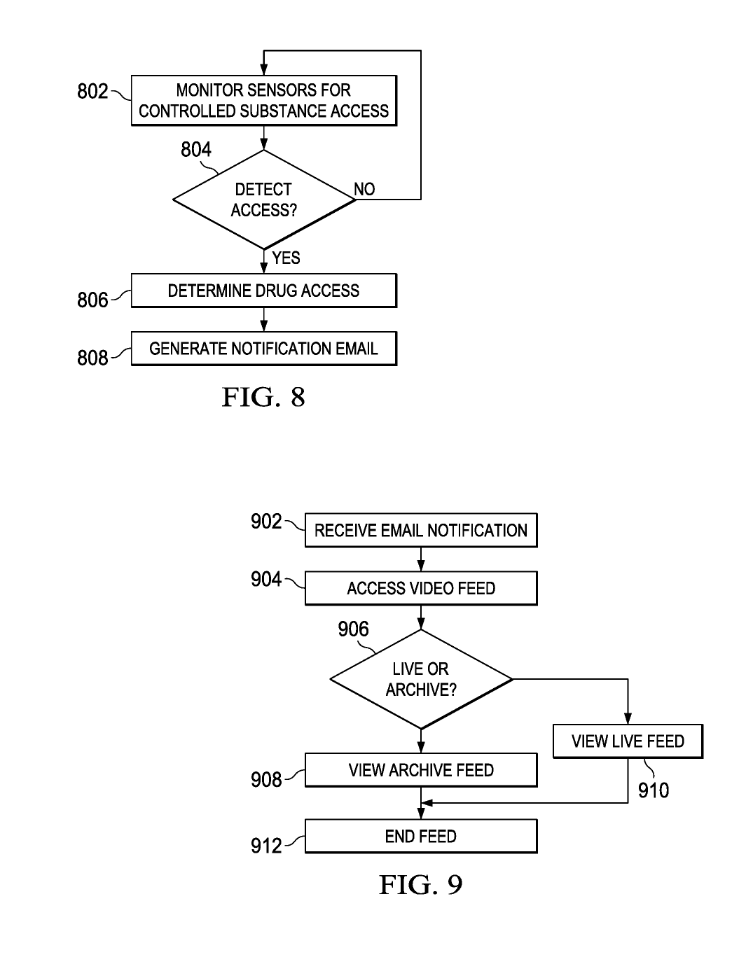

Referring now to FIG. 8, there is illustrated a flow diagram describing the manner in which the email notification generator 220 will generate an email responsive to detection of a secure canister compartment 204 access. The sensors associated with the secure canister compartment 204 are monitored at step 802 to detect possible accesses. Inquiry step 804 detects an access from one of the sensors and determines if there has been an access of the secure compartment at step 806. Once a determined access has been verified, an email notification is generated at step 808. If inquiry step 804 detects no accesses it continues to monitor the sensors for any type of access indication at steps 802 and 804.

Referring now to FIG. 9 there is illustrated the manner in which a responsible party may access the infrared DVR video feed responsive to receipt of an email notification. The email notification is received by responsible party at step 902. By accessing a link within the email at step 904 or going to a feed associated with the infrared DVR 218, the individual is able to access video feeds available for the secure canister compartment 204. Inquiry step 906 determines whether a live video feed or archived video feed is being selected. If the live video feed is selected, the live feed may be viewed at step 910. Alternatively, if an archived video feed is selected, the archived feeds from memory are viewed at step 908. Once viewing of the video feeds has been completed, the video feed may be ended at step 912.

Using the above described security dispensing system 202 remotely located medication dispensing systems may be sufficiently monitored for accesses to their schedule II medications and provide records of accesses to these medications in order to determine they are being validly accessed and used by individuals at the remote dispensing system. All accesses to the schedule II medications will have video evidence associated therewith in order to provide a proof of any unlawful or inappropriate accesses.

It will be appreciated by those skilled in the art having the benefit of this disclosure that this system and method for providing dispensing security for controlled substances within a care facility provides for secure monitoring and tracking of system use. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system for dispensing medication, comprising:
a secure first compartment for storing medications;
a lock mechanism for securing an access to the secure first compartment;
at least one sensor for detecting an access to the secure first compartment and generating an access signal responsive thereto; and
an email notification generator for generating and transmitting an email to a predetermined individual responsive to receipt of the access signal from the at least one sensor.

2. The system of claim 1, wherein the at least one sensor comprises a door sensor for detecting opening of a door of the secure first compartment and generating the access signal responsive thereto.

3. The system of claim 1, wherein the at least one sensor comprises a motion sensor for detecting movement relating to the access to the secure first compartment and generating the access signal responsive thereto.

4. The system of claim 1 further including:
a camera for generating image data of an individual accessing the secure first compartment responsive to the access signal of the at least one sensor; and
a database for storing the image data generated by the camera responsive to the access signal of the at least one sensor.

5. The system of claim 4, wherein the email notification generator includes a link within the email for accessing the generated image data associated with the access signal causing generation of the email.

6. The system of claim 1 further including:
a tracking sensor for tracking medications entering and exiting the secure first compartment; and
a controller for maintaining an inventory of contents of the secure first compartment responsive to outputs for the tracking sensor.

7. The system of claim 1 further including a second compartment for storing a second group of medications that have requirements associated therewith different from the requirements associated with the medications in the secure first compartment.

8. The system of claim 7, wherein a separating partition separates the secure first compartment from the second compartment.

9. The system of claim 1 further including a communications interface for interconnecting the email notification generator to a data transmission network.

10. A system for dispensing medication, comprising:
a secure first compartment for storing a first group of medications;
a second compartment for storing a second group of medications that have requirements associated therewith different from the requirements associated with the first group of medications in the secure first compartment, wherein a separating partition separates the secure first compartment from the second compartment;
a lock mechanism for separately securing an access to the secure first compartment and the second compartment;
at least one sensor for detecting an access to the secure first compartment and generating an access signal responsive thereto;
a camera for generating image data of an individual accessing the secure first compartment responsive to the access signal of the at least one sensor;
a database for storing the image data generated by the camera responsive to the access signal of the at least one sensor; and
an email notification generator for generating and transmitting an email to a predetermined individual responsive to receipt of the access signal from the at least one sensor.

11. The system of claim 10, wherein the at least one sensor comprises a door sensor for detecting opening of a door of the secure first compartment and generating the access signal responsive thereto.

12. The system of claim 10, wherein the at least one sensor comprises a motion sensor for detecting movement relating to the access to the secure first compartment and generating the access signal responsive thereto.

13. The system of claim 10, wherein the email notification generator includes a link within the email for accessing the generated image data associated with the access signal causing generation of the email.

14. The system of claim 10 further including:
a tracking sensor for tracking medications entering and exiting the secure first compartment; and
a controller for maintaining an inventory of contents of the secure first compartment responsive to outputs for the tracking sensor.

15. The system of claim 10 further including a communications interface for interconnecting the email notification generator to a data transmission network.

16. A system for dispensing medication, comprising:
a plurality of remotely located drug dispensing units for dispensing the medication;
a central dispensing controller for transmitting information to the plurality of remotely located drug dispensing units to manage the dispensing of the medication;
wherein the plurality of remotely located drug dispensing units further comprise:
a secure first compartment for storing medications;
a lock mechanism for securing an access to the secure first compartment;
at least one sensor for detecting an access to the secure first compartment and generating an access signal responsive thereto; and
an email notification generator for generating and transmitting an email to a predetermined individual responsive to receipt of the access signal from the at least one sensor.

17. The system of claim 16, wherein the at least one sensor comprises a door sensor for detecting opening of a door of the secure first compartment and generating the access signal responsive thereto.

18. The system of claim 16, wherein the at least one sensor comprises a motion sensor for detecting movement relating to the access to the secure first compartment and generating the access signal responsive thereto.

19. The system of claim 16 further including:
a camera for generating image data of an individual accessing the secure first compartment responsive to the access signal of the at least one sensor; and
a database for storing the image data generated by the camera responsive to the access signal of the at least one sensor.

20. The system of claim 19, wherein the email notification generator includes a link within the email for accessing the generated image data associated with the access signal causing generation of the email.

21. The system of claim 16 further including:
a tracking sensor for tracking medications entering and exiting the secure first compartment; and
a controller for maintaining an inventory of contents of the secure first compartment responsive to outputs for the tracking sensor.

22. The system of claim 16 further including a second compartment for storing a second group of medications that have requirements associated therewith different from the requirements associated with the medications in the secure first compartment.

23. The system of claim 22, wherein a separating partition separates the secure first compartment from the second compartment.

24. The system of claim 16 further including a communications interface for interconnecting the email notification generator to a data transmission network.
